(19) United States
(12) Patent Application Publication
(10) Pub. No.: US 2020/0174314 A1
(43) Pub. Date: Jun. 4, 2020

(54) POLARIZING PLATE, DISPLAY PANEL AND DISPLAY DEVICE

(71) Applicant: SHARP KABUSHIKI KAISHA, Sakai City (JP)

(72) Inventors: SHINYA MORINO, Sakai City (JP); HIROYUKI WATATANI, Sakai City (JP)

(21) Appl. No.: 16/697,035

(22) Filed: Nov. 26, 2019

Related U.S. Application Data
(60) Provisional application No. 62/773,794, filed on Nov. 30, 2018.

(51) Int. Cl. G02F 1/1335; G02B 1/14; G02B 5/30; G02F 1/1333

(52) U.S. Cl. CPC G02F 1/133528; G02F 1/13338; G02B 5/3083; G02B 1/14

(57) ABSTRACT

A polarizing plate includes: a polarizer; a hard coat layer; and a recess formed at an outer edge of the polarizing plate or a through hole bored through the polarizing plate in a thickness direction. At least the polarizer and the hard coat layer are stacked, and the hard coat layer is not formed in a stress concentration part, included in the edge at which the recess or the through hole is formed, in which stress concentrates in a case where a change in temperature of the polarizing plate is effected with the hard coat layer formed all over the polarizer.

### CROSS REFERENCE TO RELATED APPLICATION

This application claims priority from U.S. Provisional Patent Application No. 62/773,794 filed on Nov. 30, 2018. The entire contents of the priority application are incorporated herein by reference.

### TECHNICAL FIELD

The technology described herein relates to a polarizing plate, a display panel and a display device.

### BACKGROUND

In recent years, there has been a wide variety of uses for display panels such as liquid crystal panels, and there has been a demand for display panels of various shapes depending on applications. Under such circumstances, it has recently become technically possible to manufacture a display panel having a recess at an outer edge thereof or a display panel having a through hole at an outer edge thereof.

However, a display panel having a recess at an outer edge thereof or a display panel having a through hole at an outer edge thereof has such a problem that it easily suffers from the appearance of a crack at the edge at which the recess or the through hole is formed and thereby easily suffers from the occurrence of a display defect.

In view of this problem, an attempt has conventionally been made to reduce the appearance of cracks at an edge of a recess or a through hole. For example, in Japanese Unexamined Patent Application Publication No. 2018-25630, a polarizing plate includes a polarizer and protective layers disposed on both sides, respectively, of the polarizer and is intended to reduce the appearance of cracks by forming the protective layer from cellulose resin. Further, the publication also describes reducing the appearance of cracks by the shape of a recess in addition to the formation of the protective layers from cellulose resin.

However, since the technology is intended to reduce the appearance of cracks through a material of the protective layers, it has a problem with a decrease in degree of freedom in the selection of the material. Further, although the publication also describes reducing the appearance of cracks by the shape of a recess, it is difficult to change the shape in order to reduce the appearance of cracks, as the shape of a polarizing plate usually depends on operating conditions, designs, and the like.

### SUMMARY

The technology described herein is intended to reduce the appearance of large cracks while easing restrictions on the material of a hard coat layer and the shape of a recess or a through hole.

One embodiment of the technology described herein is directed to a polarizing plate including: a polarizer; a hard coat layer; and a recess formed at an outer edge of the polarizing plate or a through hole bored through the polarizing plate in a thickness direction, wherein at least the polarizer and the hard coat layer are stacked, and the hard coat layer is not formed in a stress concentration part, included in the edge at which the recess or the through hole is formed, in which stress concentrates in a case where a change in temperature of the polarizing plate is effected with the hard coat layer formed all over the polarizer.

One embodiment of the technology described herein is direction to a display panel including the polarizing plate described above.

One embodiment of the technology described herein is directed to a display device including: the display panel described above.

The appearance of large cracks can be reduced while restrictions on the material of a hard coat layer and the shape of a recess or a through hole are eased.

### BRIEF DESCRIPTION OF THE DRAWINGS

FIG. 1 is a cross-sectional view of a liquid crystal display device according to a first embodiment as taken along line B-B shown in FIG. 2.

FIG. 2 is a top view of a liquid crystal panel.

FIG. 3 is a partial cross-sectional view taken along line A-A shown in FIG. 2.

FIG. 4 is an enlarged plan view showing a planar configuration in a display area of an array substrate constituting the liquid crystal panel.

FIG. 5 is an enlarged plan view showing a planar configuration in a display area of a CF substrate constituting the liquid crystal panel.

FIG. 6 is an enlarged schematic view of cross-sections of the array substrate and a back polarizing plate at a front outer edge (section 18 shown in FIG. 2).

FIG. 7 is an enlarged schematic view showing a partial cross-section (section 18 shown in FIG. 2) of a liquid crystal panel according to a third embodiment as taken along line A-A shown in FIG. 2.

FIG. 8 is a top view of a liquid crystal panel according to a comparative example.

FIG. 9 is an enlarged schematic view of a partial cross-section of an array substrate and a back polarizing plate of the liquid crystal panel according to the comparative example.

FIG. 10 is a top view of a liquid crystal panel (comparative example) exposed to a thermal shock test.

FIG. 11 is a back view of a back polarizing plate (comparative example) exposed to a thermal shock test.

FIG. 12 is a top view (case where there are few small cracks) of a polarizing plate (comparative example) in which a recess has been formed.

FIG. 13 is a top view (case where there are many small cracks) of a polarizing plate (comparative example) in which a recess has been formed.

FIG. 14 is a top view showing a back polarizing plate (comparative example) at an early stage of a thermal shock test.

FIG. 15 is a top view showing a back polarizing plate (comparative example) with a certain degree of progression of a thermal shock test.

FIG. 16 is a graph (Reference and Condition 1) showing results of thermal shock tests for each separate condition and for each separate sample.

FIG. 17 is a graph (Reference and Condition 2) showing results of thermal shock tests for each separate condition and for each separate sample.

FIG. 18 is a cross-sectional view of a polarizing plate according to a comparative example.

### DETAILED DESCRIPTION

### First Embodiment

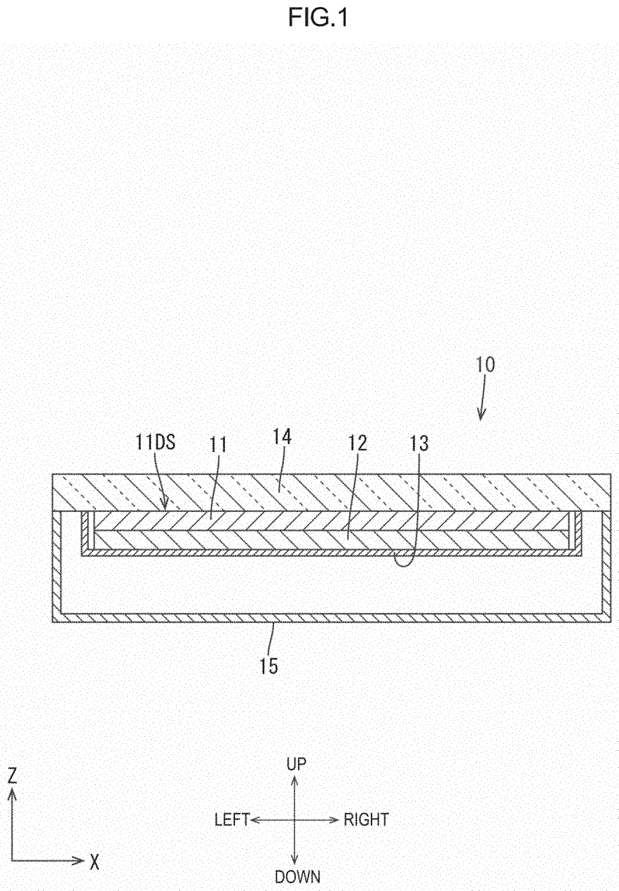

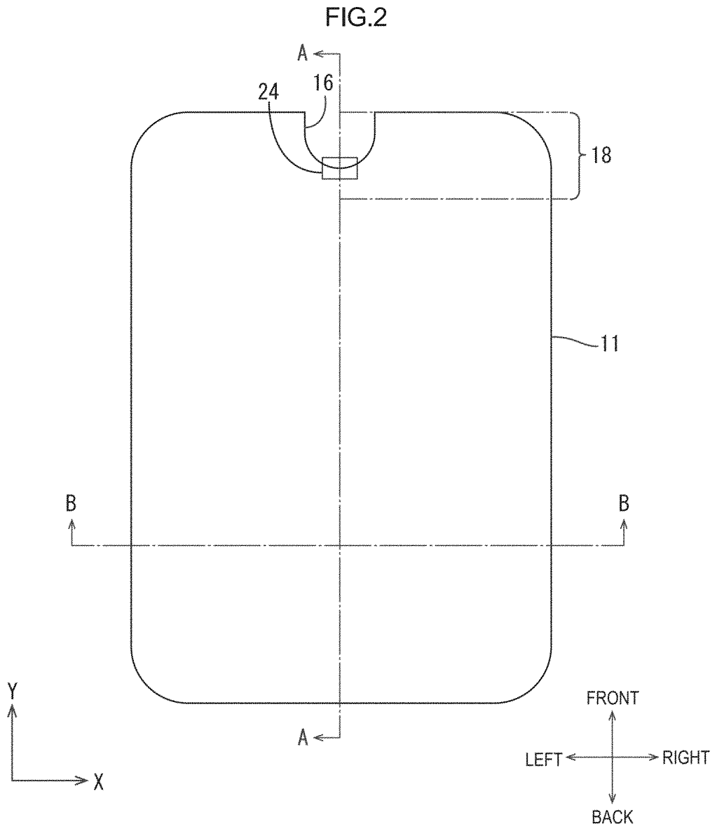

A first embodiment is described below with reference to FIGS. 1 to 6. For convenience, the following description refers to the X direction shown in FIG. 1 as a right-left direction, refers the Z direction shown in FIG. 1 as an up-down direction, and refers to the Y direction shown in FIG. 2 as a front-back direction.

### (1) Configuration of Liquid Crystal Display Device

A configuration of a liquid crystal display device 10 (which is an example of a display device) is described with reference to FIG. 1. The liquid crystal display device 10 is one that is used in electronic apparatuses such as mobile phones (including smartphones) and laptop personal computers (including tablet laptop personal computers). The liquid crystal display device 10 is not limited to these uses but may be used for any purpose.

The liquid crystal display device 10 includes a liquid crystal panel 11 (which an example of a display panel) including as a front plate surface a display surface 11DS that is capable of displaying an image, a backlight device 12 (which is an example of a lighting device), placed on a back side of the liquid crystal panel 11 (on a side of the liquid crystal panel 11 opposite to the display surface 11DS), that illuminates the liquid crystal panel 11 with light for display, a case 13 that accommodates the liquid crystal panel 11 and the backlight device 12, a cover glass (protective panel) 14 placed on a front side of the liquid crystal panel 11, and a housing 15, placed behind the case 13 and the cover glass 14, that covers the case 13 and the cover glass 14 from behind.

The liquid crystal display device 10 also includes a driver that drives the liquid crystal panel 11, a control circuit that supplies various types of input signal to the driver.

The liquid crystal panel 11 is for example a TFT (Thin Film Transistor) liquid crystal and is specifically of a TN (Twisted Nematic) type, a VA (Vertical Alignment) type, an IPS (In Plane Switching) type, or other types. A specific configuration of the liquid crystal panel 11 will be described later.

The backlight device 12 includes a light source (such as a cold-cathode tube, an LED, organic EL; and an optical member. The optical member has a function, for example, of converting light emitted from the light source into planar light. The case 13 is made of a non-conductive synthetic resin material (non-conductive material). The case 13 is substantially in the shape of a box having a frontward opening and accommodates the liquid crystal panel 11 and the backlight device 12 inside thereof.

The cover glass 14 is disposed to entirely cover the front of the liquid crystal panel 11 and is thereby intended to protect the liquid crystal panel 11. The housing 15 is made of a conductive metal material (conductive material) such as iron or aluminum. The housing 15 is substantially in the shape of a box having a frontward opening closed by the cover glass 14.

### (2) Configuration of Liquid Crystal Panel

FIG. 2 shows the overall shape of the liquid crystal panel 11. The liquid crystal panel 11 has a substantially rectangular shape and has a U-shaped recess 16 formed at an upper outer edge thereof. The recess 16 is for example a space for a lens, an operation button, or the like for a camera.

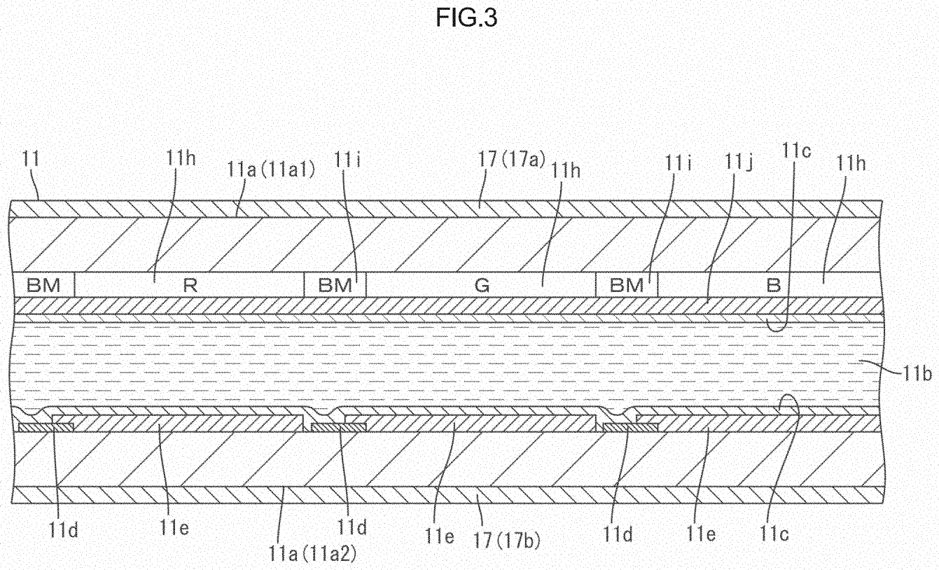

As shown in FIG. 3, the liquid crystal panel 11 includes a pair of transparent (highly translucent) substrates 11a, a liquid crystal layer 11b, and a pair of polarizing plates 17 (namely a front polarizing plate 17a and a back polarizing plate 17b).

The pair of substrates 11a each include a substantially transparent glass substrate and are configured to have a plurality of films stacked on top of the respective glass substrates by a known photolithography method. The pair of substrates 11a include a CF substrate 11a1 (display substrate, counter substrate) placed at the front (front side, upper side shown in FIG. 1) and an array substrate 11a2 (display substrate, element substrate, active matrix substrate) placed at the back (back side, lower side shown in FIG. 1). The two substrates 11a have formed on inner surfaces thereof alignment films 11c for aligning liquid crystal molecules contained in the liquid crystal layer 11b, respectively.

The pair of polarizing plates 17 are pasted to outer surfaces of the pair of substrates 11a opposite to the liquid crystal layer 11b (i.e. to the inner surfaces), respectively. Each of the polarizing plates 17 is similar in outer shape to the liquid crystal panel 11 and has outer dimensions which are one size smaller than those of the liquid crystal panel 11. A specific configuration of each of the polarizing plates 17 will be described later.

The back-side substrate 11a (array substrate) has TFTs (Thin Film Transistors) 11d and pixel electrodes 11e provided on an inner surface (which faces the liquid crystal layer 11b) of a display area on the center side of a screen on which an image is displayed.

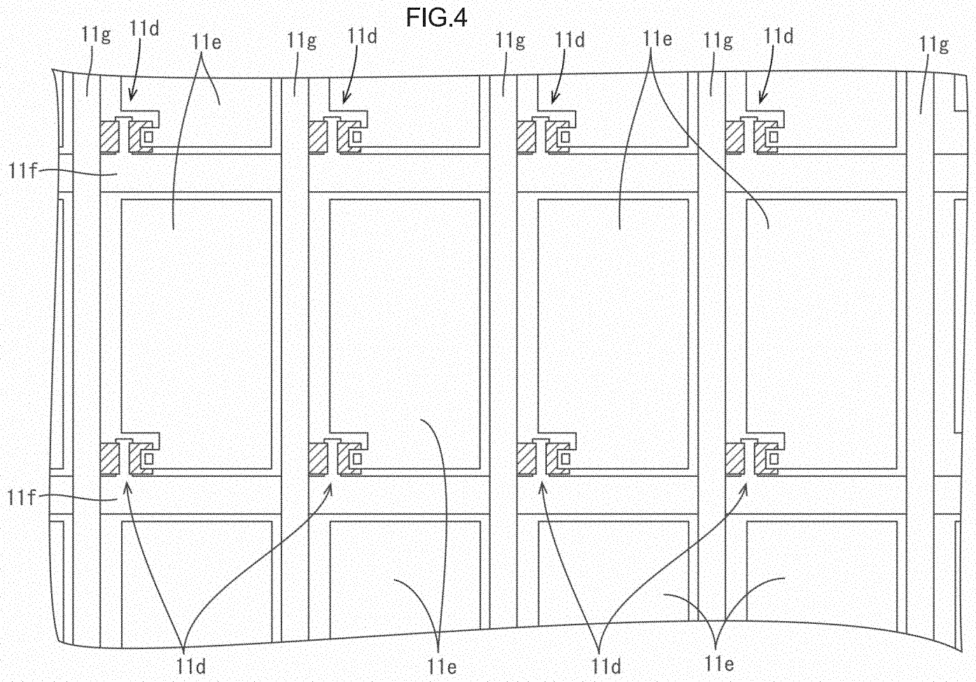

As shown in FIG. 4, a large number of the TFTs 11d and a large number of the pixel electrodes 11e are provided in a matrix arrangement. The TFTs 11d and the pixel electrodes 11e are surrounded by gate lines 11f and source lines 11g forming a grid pattern. In other words, the TFTs 11d and the pixel electrodes 11e are arranged in rows and columns at crossings between the gate lines 11f and the source lines 11g forming a grid pattern.

The gate lines 11f and the source lines 11g are connected to gate electrodes and source electrodes, respectively, of the TFTs 11d, and the pixel electrodes 11e are connected to drain electrodes of the TFTs 11d. Further, each of the pixel electrodes 11e has a vertically long square shape (rectangular shape) in plan view and is constituted by a translucent conductive film made of a highly translucent and conductive material such as ITO (Indium Tin Oxide) or ZnO (Zinc Oxide). It should be noted that the front-side substrate 11a may also be provided with capacitive wires that run parallel to the gate lines 11f and cross the pixel electrodes 11e.

As shown in FIG. 3, the front-side substrate 11a (CF substrate 11a1) has a color filter 11h provided on the inner surface of the display area on the center side of the screen on which an image is displayed.

As shown in FIG. 5, the color filter 11h has a large number of R (red), G (green), and B (blue) colored portions arranged in a matrix so as to overlap each separate pixel electrode 11e of the front-side substrate 11a in plan view. Formed between the colored portions is a substantially grid-shaped light-blocking layer (black matrix) 11i for preventing color mixture. The light-blocking layer 11i is disposed to overlap the aforementioned gate lines 11f and source lines 11g in plan view.

As shown in FIG. 3, provided on the back sides of the color filter 11h and the light-blocking layer 11i is a solid counter electrode (common electrode) 11j that faces the pixel electrodes 11e of the back-side substrate 11a.

In the liquid crystal panel 11, as shown in FIGS. 3 to 5, one display pixel serving as a unit of display is constituted by a set of R (red), G (green), and B (blue) colored portions of three colors and three pixel electrodes 11e facing the colored portions. Each display pixel is composed of a red pixel having an R colored portion, a green pixel having a G colored portion, and a blue pixel having a B colored portion. Pixels of these colors constitute a group of pixels by being repeatedly arranged along a row-wise direction on a plate surface of the liquid crystal panel 11, and a large number of these groups of pixels are arranged along a column-wise direction.

The liquid crystal panel 11 displays an image by means of light that is emitted from the backlight device 12. Specifically, light emitted from the backlight device 12 has its direction of polarization aligned when the light passes through the back-side polarizing plate 17 of the liquid crystal panel 11. The light whose direction of polarization has been aligned has its polarization state changed according to a state of alignment of the liquid crystal molecules in the liquid crystal layer 11b.

Since the state of alignment of the liquid crystal molecules contained in the liquid crystal layer 11b is controlled on the basis of potential differences generated between the pixel electrodes 11e and the counter electrode 11j, the polarization state of transmitted light is controlled for each separate pixel electrode 11e (i.e. for each separate display pixel). Light having passed through the liquid crystal layer 11b passes through the color filter 11h, thereby turns into light of colors corresponding to each separate colored portion, and is emitted through the front-side polarizing plate 17. Amounts of light that are emitted by this liquid crystal panel 11 are individually controlled for each separate display pixel, whereby a predetermined color image is displayed.

### (3) Configuration of Polarizing Plates

In this part of the specification, the back polarizing plate 17b is described first, and then the front polarizing plate 17a is described.

(3-1) Back Polarizing Plate

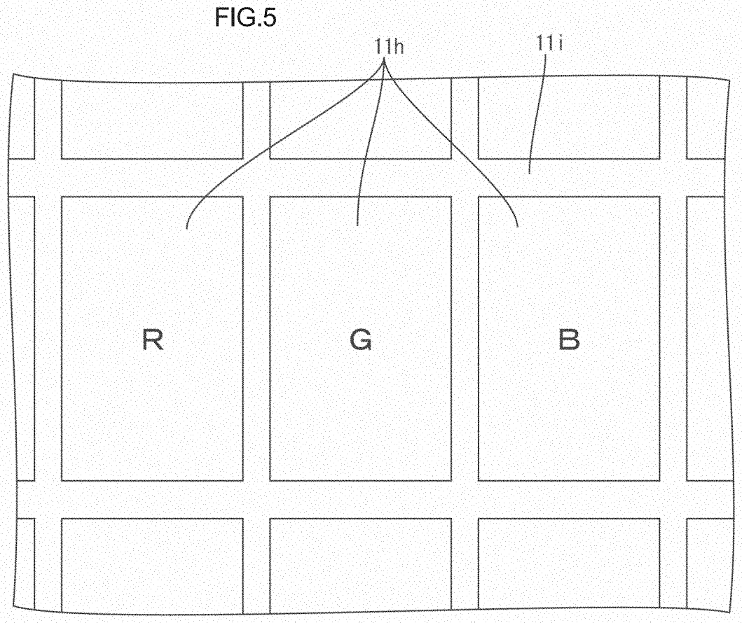

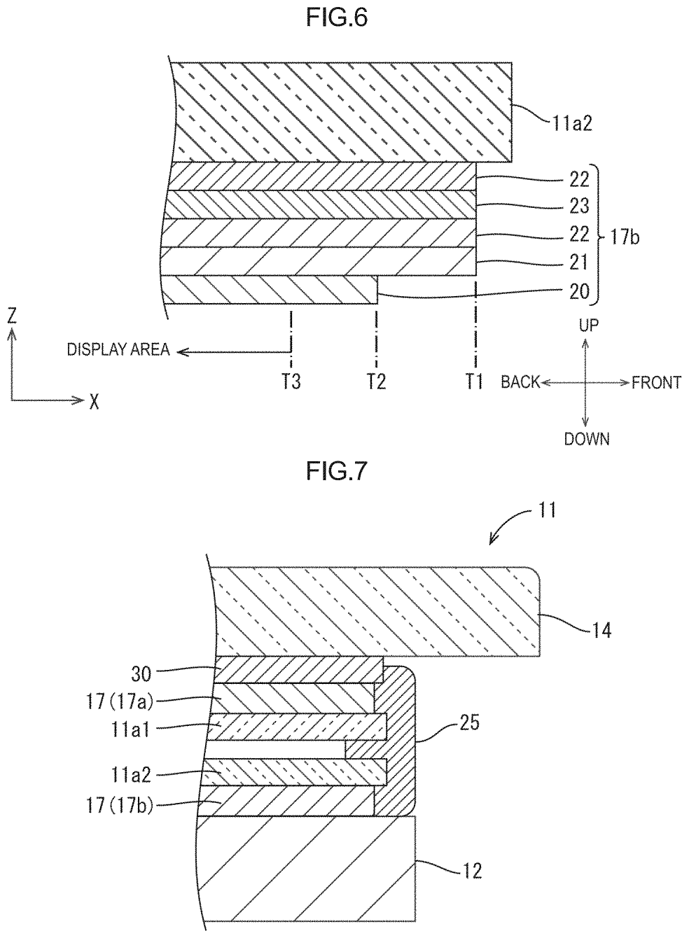

As shown in FIG. 6, the back polarizing plate 17b includes a hard coat layer 20, a luminance-improving film 21, a pressure-sensitive adhesive (PSA) 22, a polarizer 23, and a pressure-sensitive adhesive 22 that are stacked in this order from the bottom.

The hard coat layer 20 serves to protect a surface of the luminance-improving film 21 opposite to a surface of the luminance-improving film 21 pasted to the polarizer 23 (for example, to prevent the luminance-improving film 21 from being scratched and prevent adhesion between the luminance-improving film 21 and the backlight device 12). The hard coat layer 20 is made, for example, of PET (Polyethylene Terephthalate). The material of the hard coat layer 20 is not limited to PET but may be selected as appropriate.

The luminance-improving film 21 serves to improve the luminance of light emitted from the backlight device 12. Usable examples of the luminance-improving film 21 include an APCF (manufactured by Sumitomo 3M Limited), a DBEF (manufactured by Sumitomo 3M Limited), and similar films.

The polarizer 23 serves to transmit only light that oscillates only in one particular direction and block light that oscillates in other directions. The polarizer 23 is formed, for example, by uniaxially stretching a polyvinyl alcohol film dyed with iodine. It should be noted that the polarizer 23 is not limited to this but may be selected as appropriate.

In the back polarizing plate 17b, as shown in FIG. 6, the luminance-improving film 21, the pressure-sensitive adhesive 22, the polarizer 23, and the pressure-sensitive adhesive 22 have their front ends aligned with one another. On the other hand, the hard coat layer 20 has its front end located in a position T2 that is behind a position T1 of the other layers such as the polarizer 23 (toward the inside of the back polarizing plate 17b). The following description refers to “the hard coat layer 20 having its front end located in the position T2 that is behind the position T1 of the other layers” as “the hard coat layer 20 being offset”.

A range within which the hard coat layer 20 is offset is described with reference to FIG. 2. An area 24 indicated by a rectangular frame in FIG. 2 is a stress concentration part in which stress concentrates due to differences in coefficient of linear expansion/thermal hysteresis among the layers in a case where an experimental liquid crystal panel 11 whose hard coat layer 20 is not offset is exposed to a thermal shock test. The position of the stress concentration part can be comparatively easily identified by an analysis that involves the use of a finite element method, even if the stress concentration part is somewhat complex in shape. The area 24 is hereinafter referred to as “stress concentration part 24”.

In the back polarizing plate 17b according to first embodiment, the hard coat layer 20 is offset only in the stress concentration part 24 in which stress has concentrated in the aforementioned experimental liquid crystal panel 11. In other words, the back polarizing plate 17b has no hard coat layer formed only in the stress concentration part 24, included in the edge at which the recess 16 is formed, in which stress concentrates in a case where a change in temperature of the back polarizing plate 17b is effected with the hard coat layer 20 formed all over the polarizer 23.

Next, a method for offsetting the hard coat layer 20 is described. In the present embodiment, the hard coat layer 20 is removed (i.e. offset) by dissolving the hard coat layer 20 with a solvent. The hard coat layer 20 has inorganic properties, and the other layers have organic properties. For this reason, appropriate selection of the solvent makes it possible to selectively offset only the hard coat layer 20.

It should be noted that although, in first embodiment, the hard coat layer 20 is offset only in the stress concentration part 24, the hard coat layer 20 may also be offset as need in other parts. However, offsetting other parts requires a larger number of steps of removing the hard coat layer 20. On the other hand, offsetting the hard coat layer 20 only in the stress concentration part 24 makes it possible to minimize the number of steps for reducing the appearance of cracks.

Next, an offset amount of the hard coat layer 20 is described with reference to FIG. 6. The formation of the recess 16 entails the appearance of small cracks at the edge of the liquid crystal panel 11 at which the recess 16 is formed. According to the investigation done by the inventor of the present application, those small cracks which appeared during the formation of the recess 16 in the back polarizing plate 17b had lengths of less than 0.1 mm, albeit depending on the processing conditions under which the recess 16 was formed. Further, the display area of the liquid crystal panel 11 has its front end T3 located approximately 0.5 mm behind the position T1.

The offset amount of the hard coat layer 20 ranges from 0.1 mm to less than 0.5 mm behind the position T1 (toward the inside of the back polarizing plate 17b). That is, the hard coat layer 20 has its front end (which is an example of an outer edge) located behind the front end (which is an example of an outer edge) of the polarizer 23 by the lengths of those small cracks which appeared during the formation of the recess 16 in the back polarizing plate 17b and located in front of the front end of the display area of the liquid crystal panel 11.

(3-2) Front Polarizing Plate

The front polarizing plate 17a is substantially identical in configuration to the back polarizing plate 17b except that the hard coat layer 20 is not offset.

### (4) Effects of the Embodiment

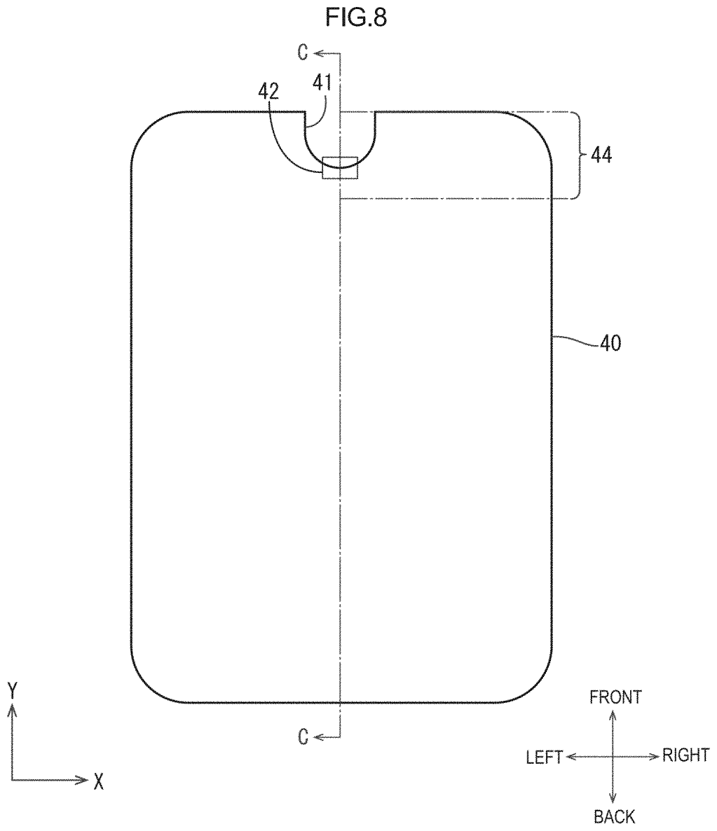

Effects of the back polarizing plate 17b according to first embodiment are described with reference to a comparative example. As shown in FIG. 8, a liquid crystal panel 40 according to the comparative example is substantially rectangular in overall shape as is the case with the liquid crystal panel 11 (see FIG. 2) according to first embodiment and has a U-shaped recess 41 formed at an upper outer edge thereof.

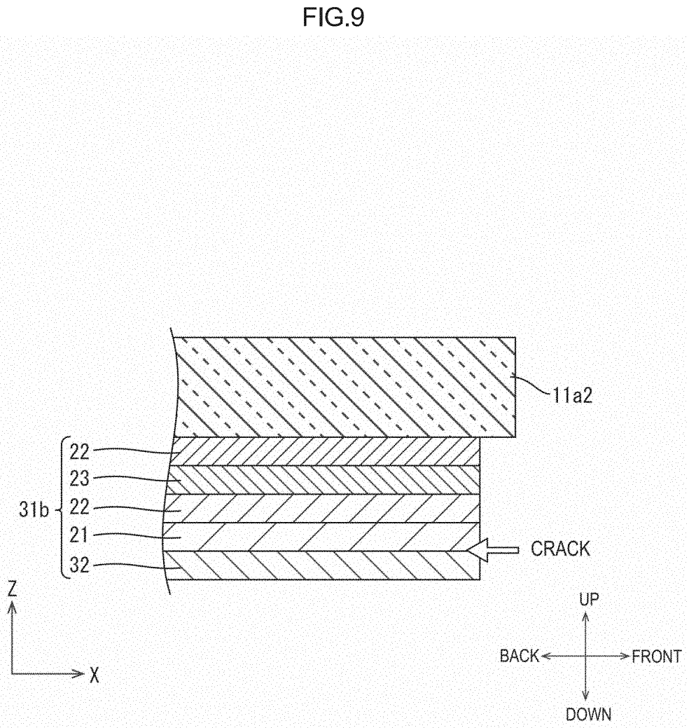

FIG. 9 is an enlarged view of an array substrate 11a2 and a back polarizing plate 31b of the liquid crystal panel 40 according to the comparative example. The back polarizing plate 31b includes a hard coat layer 32, a luminance-improving film 21, a pressure-sensitive adhesive (PSA) 22, a polarizer 23, and a pressure-sensitive adhesive (PSA) 22 that are stacked in this order from the bottom. In the back polarizing plate 31b according to the comparative example, as shown in FIG. 9, these layers have their front ends aligned with one another. That is, the liquid crystal panel 40 has the hard coat layer 32 formed all over the polarizer 23. In other words, the liquid crystal panel 40 is equivalent to the aforementioned experimental liquid crystal panel 11.

The inventor of the present application exposed the liquid crystal panel 40 according to the comparative example to a thermal shock test. The thermal shock test was repeated a hundred cycles under such conditions that the range of changes in temperature was −40° C. to 80° C., the residence time at each temperature was thirty minutes, the duration of transition from a low temperature (−40°±5° C.) to a high temperature (80° C.±5° C.) was five minutes or shorter, and the duration of transition from a high temperature to a low temperature was similarly five minutes or shorter.

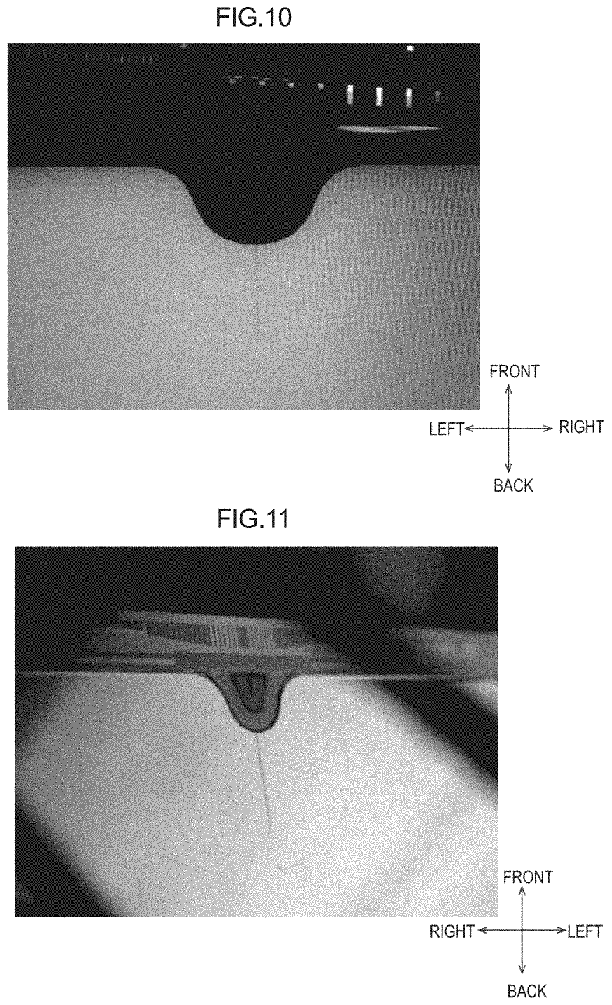

FIG. 10 shows the liquid crystal panel 40 exposed to a thermal shock test. As a result of the thermal shock test, the liquid crystal panel 40 according to the comparative example suffered from a display defect in the form of a line extending in a longitudinal direction (front-back direction) from an edge of the recess 41.

FIG. 11 shows the back polarizing plate 31b as a separate part separated from the liquid crystal panel 40 subjected to the aforementioned thermal shock test. In the liquid crystal panel 40 according to the comparative example, the back polarizing plate 31b had a large crack extending in a longitudinal direction from the edge of the recess 41. Note here that a front polarizing plate 31a and the back polarizing plate 31b have their polarizing axes orthogonal to each other, and the longitudinal crack appears in either of the polarizing plates. In the case of the liquid crystal panel 40 according to the comparative example, a crack appeared in the back polarizing plate 31b. Viewability of cracks having appeared in the polarizing plates 31 is expressed as “Front Polarizing Plate 31a>Back Polarizing Plate 31b”; however, since the cracks have reached a level at which the polarizer 23 is located, they affect a display regardless of whether they are in the front or the back.

A quadrangular liquid crystal panel 40 having no recess 41 or through hole had no such crack even under the same test conditions (a profile of rising and lowering temperatures and number of times). For this reason, the inventor of the present application investigated the cause of the appearance of the crack in the back polarizing plate 31b. The following describes the investigation done by the inventor of the present application and findings obtained by the investigation.

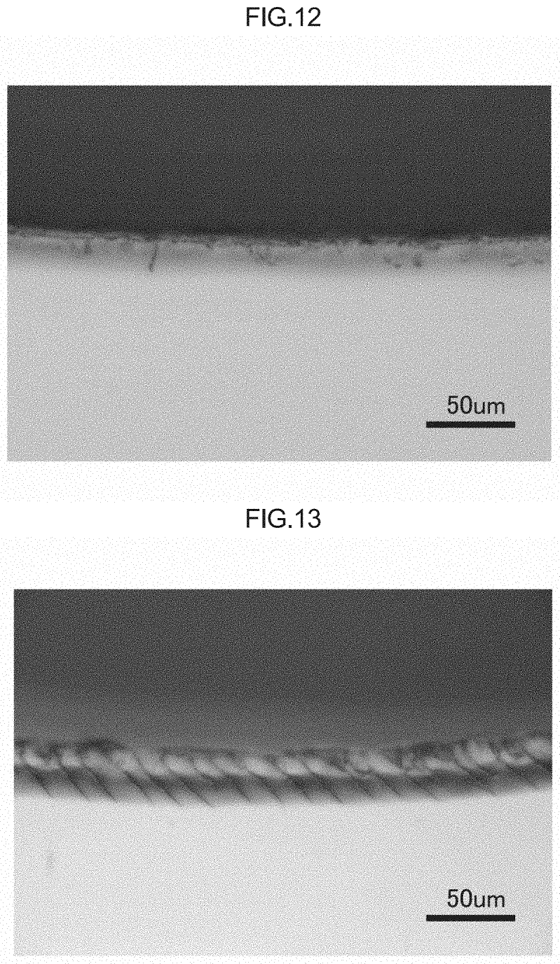

The recess 41 formed in the back polarizing plate 31b is formed by processing the outer shape of the back polarizing plate 31b with a tool such as a drill. As shown in FIGS. 12 and 13, the inventor of the present application found small cracks at the edge of the recess 41 as a result of observing the back polarizing plate 31b after the formation of the recess 41. These cracks are ones that appeared during the processing. An area where cracks appear as a result of processing is generally referred to as “delamination area”. The number and size of cracks that appear as a result of processing depend greatly on the layer construction and processing condition of the back polarizing plate 31b and vary. For this reason, there are a case where the number of cracks is small as shown in FIG. 12 and a case where the number of cracks is large as shown in FIG. 13.

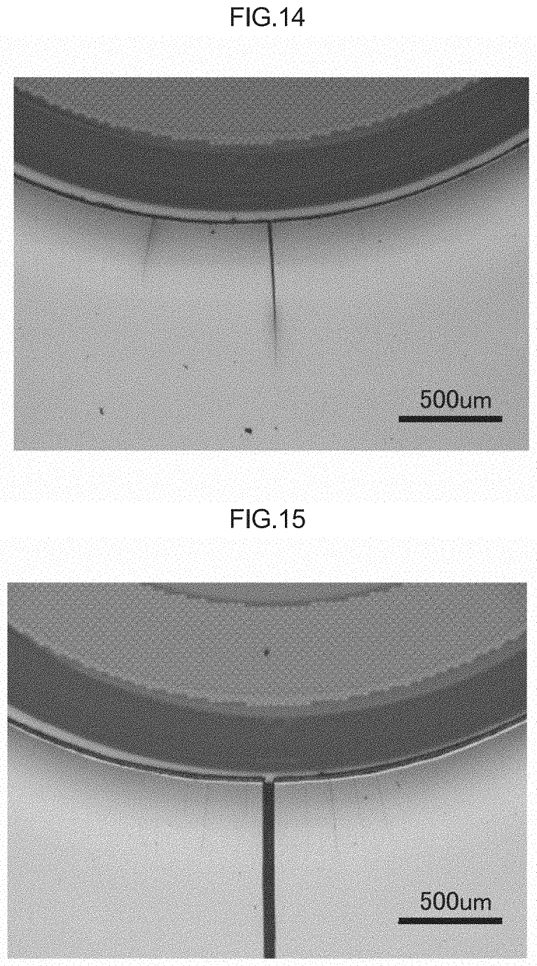

FIGS. 14 and 15 show how cracks grow in the back polarizing plate 31b according to the comparative example during a thermal shock test. FIG. 14 shows the back polarizing plate 31b at an early stage of the thermal shock test, and FIG. 15 shows the back polarizing plate 31b with a certain degree of progression of the test. The inventor of the present application found by observation that cracks appear in surface layers (namely the hard coat layer 32 and the luminance-improving film 21) and grow with progression of the test.

Further, the inventor of the present application conducted a thermal shock test on the back polarizing plate 31b according to the comparative example with a plurality of samples. As a result of that, the locations of appearance of cracks in any of the samples fell within a comparative narrow range (i.e. a range indicated by a rectangular frame 42 in FIG. 8) centered at a vertex of the recess 41. The comparatively narrow range centered at the vertex of the recess 41 is hereinafter referred to as “area around the vertex of the recess 41”.

In general, application of heat to a structural body obtained by bonding together members having different coefficients of linear expansion causes generation of internal stress at a shape singular point. The inventor of the present application identified a stress concentration part by an analysis that involves the use of a finite element method. As a result of that, the area around the vertex of the recess 41 was a stress concentration part in the case of a U-shaped recess 41. That is, the area around the vertex of the recess 41 is a shape singular point at which stress concentrates, whereby stress concentrated.

Concentration of stress in the area around the vertex of the recess 41 causes the back polarizing plate 31 to relax its stress by splitting from the area around the vertex of the recess 41. That is, cracks appear. For this reason, stress concentration leads to a great decrease in crack resistance.

From the foregoing, the inventor of the present application obtained the following three findings:

Finding 1: Small cracks appear at the edge of the back polarizing plate 31 during the formation of the recess 41 or the through hole in the back polarizing plate 31b.

Finding 2: A part of the edge at which the recess 41 or the through hole is formed becomes a stress concentration part (i.e. a shape singular point at which stress concentrates), so that small cracks having appeared at the edge grow under the stress.

Finding 3: Cracks appear in the surface layers (namely the hard coat layer 32 and the luminance-improving film 21) of the back polarizing plate 31b.

Having had obtained these findings, the inventor of the present application conducted an experiment to find out how the appearance of cracks and the hard coat layer 32 relate to each other. Specifically, the inventor of the present application prepared a plurality of experimental back polarizing plates 31b under the following conditions (Reference and Condition 1), respectively, pasted them to liquid crystal panels 40, and exposed them to thermal shock tests.

Reference (Ref): Luminance-improving film 21+Hard coat layer 32

Condition 1: Luminance-improving film 21 (with no hard coat layer 32)

Note here that Reference is a back polarizing plate 31b according to the aforementioned comparative example. Condition 1 is a back polarizing plate 31b according to the comparative example with no hard coat layer 32.

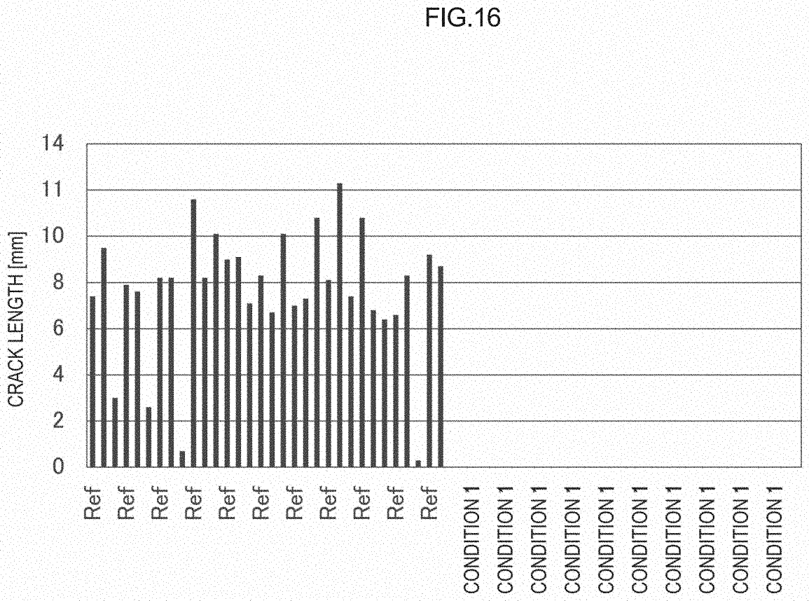

FIG. 16 is a graph showing results of the aforementioned experiment. FIG. 16 shows, for each of the plurality of samples under the respective conditions, the lengths of cracks that appeared. As is evident from FIG. 16, cracks appeared in all of the samples in Reference, although the cracks varied in size. On the other hand, no cracks appeared in any of the samples under Condition 1. From this, it was found that the appearance of cracks can be reduced by eliminating the hard coat layer 32.

However, since the hard coat layer 32 is intended to protect the luminance-improving film 21 (for example, to prevent the luminance-improving film 21 from being scratched and prevent adhesion between the luminance-improving film 21 and the backlight device 12), the hard coat layer 32 cannot be totally eliminated.

After consideration of this matter, the inventor of the present application found that the appearance of cracks can be reduced by eliminating the hard coat layer 32 from at least the stress concentration part, even without totally eliminating the hard coat layer 32.

A back polarizing plate 17b according to first embodiment is a back polarizing plate 17b including: a polarizer 23; a hard coat layer 20; and a recess 16 formed at an outer edge of the back polarizing plate 17b, wherein at least the polarizer 23 and the hard coat layer 20 are stacked, and the hard coat layer 20 is not formed in a stress concentration part 24, included in the edge at which the recess 16 is formed, in which stress concentrates in a case where a change in temperature of the back polarizing plate 17b is effected with the hard coat layer 20 formed all over the polarizer 23.

That is, since back polarizing plate 17b has no hard coat layer in the stress concentration part 24 while including the hard coat layer 20, the appearance of large cracks can be reduced regardless of the material of the hard coat layer 20 or the shape of the recess 16. Therefore, the back polarizing plate 17b makes it possible to reduce the appearance of large cracks while easing restrictions on the material of the hard coat layer 20 and the hole shape of the recess 16.

Note here that although the back polarizing plate 17b includes the hard coat layer 20 and a luminance-improving film 21, cracks can appear even when the back polarizing plate 17b is configured to include no luminance-improving film 21 (i.e. configured to have the hard coat layer 20 formed directly on the polarizer 23). This is described in listed above. Even in a configuration with no luminance-improving film 21, the appearance of large cracks can be reduced by removing the hard coat layer 20 from the stress concentration part 24.

Further, the back polarizing plate 17b is configured such that in the stress concentration part 24, the hard coat layer 20 has its outer edge located toward an inside of the back polarizing plate 17b from an outer edge of the polarizer 23 by a length of a crack having appeared during formation of the recess 16 in the back polarizing plate 17b. The back polarizing plate 17b causes a small crack having appeared during the formation of the recess 16 (i.e. a small crack from which a large crack develops) to be removed when the hart coat layer 20 is removed. This makes it possible to more surely reduce the possibility of the appearance of a large crack.

Note here that whether the outer edge of the hard coat layer 20 is located toward the inside of the back polarizing plate 17b from the outer edge of the polarizer 23 by the length of a crack having appeared during the formation of the recess 16 in the back polarizing plate 17b can be determined by making a comparison with the length of a crack having appeared in a part, included in the edge at which the recess 16 is formed, from which the hard coat layer 20 has not been removed.

A liquid crystal panel 11 according to first embodiment includes a back polarizing plate 17b. The liquid crystal panel 11 makes it possible to reduce the appearance of large cracks while easing restrictions on the material of the hard coat layer 20 and the shape of the recess 16.

Further, the liquid crystal panel 11 is configured such that in the stress concentration part 24, the hard coat layer 20 has its outer edge located in a position outside a display area of the liquid crystal panel 11. If the outer edge of the hard coat layer 20 is located within the display area of the liquid crystal panel 11, the display area includes a mixture of an area where the hard coat layer 20 is present and an area where the hard coat layer 20 is not present, and such a mixture may cause a decrease in image quality. The liquid crystal panel 11 makes it possible to suppress a decrease in image quality even when the hard coat layer 20 is removed, as the outer edge of the hard coat layer 20 is located in a position outside the display area of the liquid crystal panel (that is, as the outer edge of the hard coat layer 20 is not located within the display area of the display panel).

A liquid crystal display device 10 according to first embodiment includes: a liquid crystal panel 11; and a backlight device 12. The liquid crystal display device 10 makes it possible to reduce the appearance of large cracks while easing restrictions on the material of the hard coat layer 20 and the shape of the recess 16.

### Second Embodiment

In second embodiment, the hard coat layer 20 is offset as in the case of first embodiment, and the luminance-improving film 21 is made thinner so that the appearance of cracks can be more surely reduced. For reduction of the appearance of cracks, it is desirable that the luminance-improving film 21 have a thickness of 25 μm or smaller, more desirably 20 μm or smaller.

Effects of the back polarizing plate 17b according to second embodiment are described with reference to the comparative example. The inventor of the present application prepared a plurality of back polarizing plates 31b (see FIG. 9) according to the comparative example under the following conditions (Reference and Condition 2), respectively, pasted the back polarizing plates 31b according to the comparative example thus prepared to liquid crystal panels 40, and exposed them to thermal shock tests.

Reference (Ref): Luminance-improving film 21 whose thickness is greater than 25 μm+Hard coat layer 32

Condition 2: Luminance-improving film 21 whose thickness is 25 μm or smaller+Hard coat layer 32

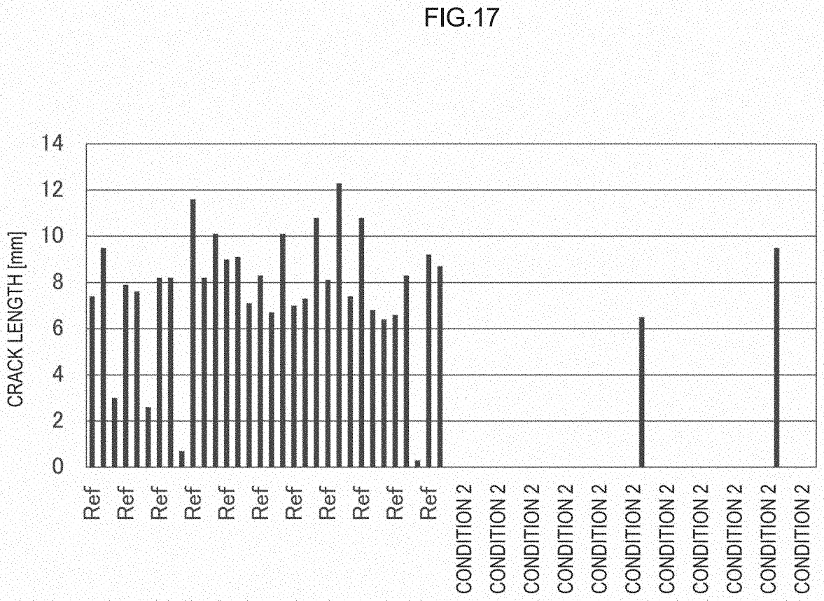

FIG. 17 is a graph showing results of the aforementioned experiment. Under Condition 2, cracks appeared in two samples, but no cracks appeared in the other samples. This means a great reduction of the appearance of cracks as compared with Reference. A reason for the great reduction of the appearance of cracks is that the decrease in thickness of the luminance-improving film 21 led to a reduction in stress that is applied in the case of a change in temperature of the back polarizing plate 31b.

In the back polarizing plate 17b according to second embodiment, the luminance-improving film 21 has a thickness of 25 μm or smaller. For this reason, the appearance of cracks at the edge at which the recess 16 is formed can be more surely reduced than in a case where the luminance-improving film 21 has a thickness of greater than 25 μm.

### Third Embodiment

In third embodiment, the hard coat layer 20 is offset as in the case of first embodiment, and a waterproof layer is formed on an end face of the stress concentration part 24 so that the appearance of cracks can be more surely reduced. Specifically, as shown in FIG. 7, the back polarizing plate 17b according to third embodiment includes resin 25 (which is an example of the waterproof layer) entirely covering the end face of the stress concentration part 24. Note here that a layer 30 between the cover glass 14 and the front polarizing plate 17a in FIG. 7 is an adhesive.

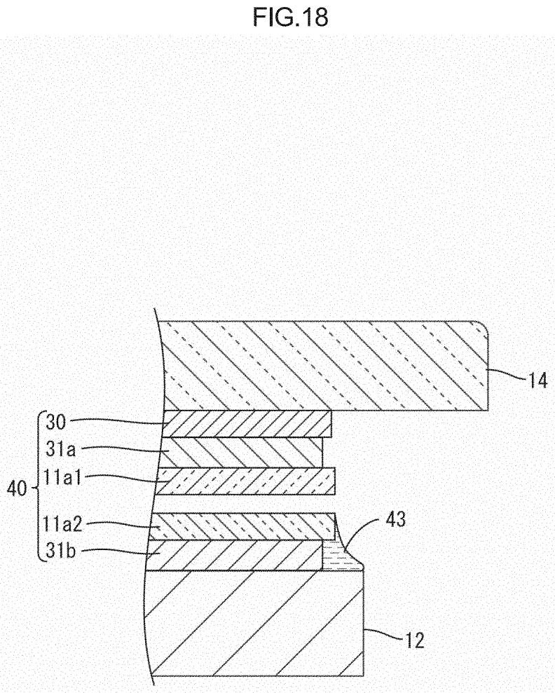

Effects of the back polarizing plate 17b according to third embodiment is described with reference to a comparative example. FIG. 18 shows a liquid crystal panel 40 according to the comparative example. When the liquid crystal panel 40 is exposed to a thermal shock test, water 43 adheres to the liquid crystal panel 40 due to condensation in the process of transition from a low temperature to a high temperature. The amount of water 43 that adheres is determined by high-temperature/low-temperature temperature conditions, its transition speed, and the thermal capacity of the liquid crystal panel 40, and under test conditions (where the range of changes in temperature is −40° C. to 80° C., the residence time at each temperature is thirty minutes, the duration of transition from a low temperature (−40°±5° C.) to a high temperature (80° C.±5° C.) is five minutes or shorter, the duration of transition from a high temperature to a low temperature is similarly five minutes or shorter. Note, however, that in most cases, the duration of transition is shorter thanks to enhancement in performance of a test layer) that are imposed on the liquid crystal panel 40 for use, for example, in a portable module or the like, condensation is certain to occur in each and every process of transition from a low temperature to a high temperature. This condensation occurs in actual operating conditions and therefore is not confined to tests.

Since the recess 41 is more intricate than the other areas, it is often hard to drain the condensed water 43, so that the condensed water 43 remains for a longer period of time. A crack in a polarizing plate is known to grow by contact of water with an end face of the polarizing plate. For this reason, the occurrence of condensation leads to a decrease in crack resistance of the back polarizing plate 31b.

In the back polarizing plate 17b according to third embodiment, the waterproof layer is formed on the end face of the stress concentration part 24 from which a crack starts. This makes it hard for the end face of the stress concentration part 24 to make contact with water. This leads to an improvement in crack resistance and makes it possible to more surely reduce the appearance of cracks.

It should be noted that the waterproof layer may be formed by subjecting the end face of the stress concentration part 24 to water-repellent finishing (fluoride coating) instead of covering the end face of the stress concentration part 24 with the resin 25. In the case of water-repellant finishing, too, it becomes hard for the back polarizing plate 17b to make contact with water, so that similar effects can be brought about.

### Other Embodiments

The technology described herein is not limited to the embodiments described above with reference to the drawings. The following embodiments may be included in the technical scope of the technology described herein.

(1) Although each of the foregoing embodiments has been described by taking a U-shaped recess 16 as an example of a recess 16, the shape of the recess 16 is not limited to this. For example, the recess 16 may be semicircular, rectangular, trapezoidal, or triangular in shape. Normally, in a case where the recess 16 is semicircular or rectangular in shape, an area around its apex serves a stress concentration part. Further, in a case where the recess 16 has a flat portion as in the case of a rectangle or a trapezoid, areas around both ends of the flat portion serve as stress concentration parts. In the case of these shapes, too, it is only necessary to remove the hard coat layer 20 from the stress concentration part(s).

(2) Each of the foregoing embodiments has been described by taking, as an example, a case where the recess 16 is formed in the liquid crystal panel 11. Alternatively, a through hole may be formed in the liquid crystal panel 11. Moreover, the hard coat layer 20 may be removed from a stress concentration part, included in the edge of the polarizing plate 17 at which the through hole is formed, in which stress concentration in the case of a change in temperature of the polarizing plate 17.

(3) Each of the foregoing embodiments has been described by taking, as an example, a case where the hard coat layer 20 of the back polarizing plate 17b is removed. Alternatively, in a case where a crack extending in a longitudinal direction (i.e. the front-back direction shown in FIG. 2) appears not in the back polarizing plate 17b but in the front polarizing plate 17a, the hard coat layer 20 of the front polarizing plate 17a may be removed. Alternatively, both the front polarizing plate 17a and the back polarizing plate 17b may have their hard coat layers 20 removed.

(4) In each of the foregoing embodiments, the formation of the hard coat layer 20 in the stress concentration part 24 is prevented by forming the hard coat layer 20 all over a back surface of the luminance-improving film 21 and then removing the hard coat layer 20 from the stress concentration part 24. Alternatively, the formation of the hard coat layer 20 in the stress concentration part 24 may be prevented by not forming the hard coat layer 20 in the stress concentration part 24 in the first place in forming the hard coat layer 20 on the back surface of the luminance-improving film 21.

(5) In second embodiment described above, the hard coat layer 20 is offset as in the case of first embodiment, and the luminance-improving film 21 is made thinner. Alternatively, it is possible to make the luminance-improving film 21 thinner without offsetting the hard coat layer 20. That is, in the back polarizing plate 31b according to the aforementioned comparative example, the luminance-improving film 21 may have a thickness of 25 μm or smaller.

(6) In third embodiment described above, the hard coat layer 20 is offset as in the case of first embodiment, and a waterproof layer is formed on an end face of the stress concentration part 24. Alternatively, it is possible to form the waterproof layer on the end face of the stress concentration part 24 of the polarizer 17 without offsetting the hard coat layer 20. That is, in the back polarizing plate 31b according to the aforementioned comparative example, the waterproof layer may be formed on the end face of the stress concentration part 24.

(7) Although each of the foregoing embodiments has described a display panel by taking the liquid crystal panel 11 as an example, the display panel may be an organic EL panel, a PDP (Plasma Display Panel), a MEMS (Micro Electro Mechanical Systems) display, an EPD (electrophoretic display panel), or the like.

(8) Although the liquid crystal display device 10 described in each of the foregoing embodiments does not include a touch panel, the liquid crystal display device 10 may include a touch panel.

1. A polarizing plate comprising:
a polarizer;
a hard coat layer; and
a recess formed at an outer edge of the polarizing plate or a through hole bored through the polarizing plate in a thickness direction,
wherein at least the polarizer and the hard coat layer are stacked, and
the hard coat layer is not formed in a stress concentration part, included in the edge at which the recess or the through hole is formed, in which stress concentrates in a case where a change in temperature of the polarizing plate is effected with the hard coat layer formed all over the polarizer.

2. The polarizing plate according to claim 1, further comprising a luminance-improving film sandwiched between the polarizer and the hard coat layer,
wherein the luminance-improving film has a thickness of 25 μm or smaller.

3. The polarizing plate according to claim 1, further comprising a waterproof layer formed on an end face of the stress concentration part.

4. The polarizing plate according to claim 1, wherein in the stress concentration part, the hard coat layer has its outer edge located toward an inside of the polarizing plate from an outer edge of the polarizer by a length of a crack having appeared during formation of the recess or the through hole in the polarizing plate.

5. A display panel comprising the polarizing plate according to claim 1.

6. The display panel according to claim 5, wherein in the stress concentration part, the hard coat layer has its outer edge located in a position outside a display area of the display panel.

7. A display device comprising:
the display panel according to claim 5; and
a lighting device.
